(19) United States
(12) Patent Application Publication
(10) Pub. No.: US 2014/0279254 A1
(43) Pub. Date: Sep. 18, 2014

(54) SYSTEMS AND METHODS FOR CONFIGURING AND PROVISIONING PRODUCTS

(71) Applicant: LEVEL 3 COMMUNICATIONS, LLC, Broomfield, CO (US)

(72) Inventor: James Hastman, Aurora, CO (US)

(73) Assignee: Level 3 Communications, LLC, Broomfield, CO (US)

(21) Appl. No.: 13/841,209

(22) Filed: Mar. 15, 2013

(51) Int. Cl. G06Q 30/06

(52) U.S. Cl. CPC G06Q 30/0641
USPC 705/26.62

(57) ABSTRACT

Aspects of the present disclosure disclose systems and methods for providing order configuration platform that automatically enables communications service providers to define and configure products and/or services and subsequently offer such products and/or services to customers in near real-time. Additionally, the order configuration platform may enable customer to submit order for the various products and/or services. More particularly, one or more interactive interfaces, dynamically driven by a products catalog, may be generated that enable communications service providers to automatically process orders received from customers for such products.

### TECHNICAL FIELD

Aspects of the present disclosure relate to methods and systems for facilitating the quoting and ordering of communications products and services. In particular, a quoting and order entry platform for providing communications products and/or services is disclosed.

### BACKGROUND

With the advent of wired and wireless networking, the communications industry has been transformed from mainly providing telephone services to providing numerous network services and providing the infrastructure to handle such services including access to the Internet. The unprecedented demand for high-speed network services traffic, particularly for voice, data and video services, has thus transformed the communications industry. Moreover, communications service providers are constantly offering upgraded or new communications products and services to customers. Among the services provided are collaboration and cloud computing services, content delivery and distribution services, and voice over internet protocol services. A customer, such as an Internet Television network provider, may, for example, obtain content delivery and distribution services from a communications services provider so that they can ensure their broadcast content is provided to users in a fast and efficient manner using the communication provider's network and services.

In addition to the communication providers offering such products and services to customers, it is necessary to provide the mechanisms to process customer's orders for such products and services. Conventional methods for processing customer orders typically involve using proprietary order management systems of limited functionality or purchasing third party software capable of managing customer orders. In either case, when a communications service provider seeks to offer new products and services and/or modify existing products and services, the communications service provider must employ developers to add functionality to the ordering system or modify existing functionality, both of which are time consuming and expensive.

It is with these concepts in mind, among others, that various aspects of the present disclosure were conceived and developed.

### SUMMARY

Aspects of the present disclosure include a communications product quoting and ordering system. The system includes at least one processor to define at least one question corresponding to at least one product of a plurality of products defined in a product catalog. The system also includes a rendering engine to generate one or more user-interfaces for ordering the at least one product from the product catalog, the one or more user-interfaces displaying the product and the at least one question.

Aspects of the present disclosure include a method for product quoting and ordering. The method may be executed by at least one processor. The method includes defining at least one question corresponding to at least one product of a plurality of products defined in a product catalog. The method further includes generating one or more user-interfaces for ordering the at least one product from the product catalog, the one or more user-interfaces displaying the product and the at least one question.

Aspects of the present disclosure include non-transitory computer readable mediums encoded with instructions for ordering products. The instructions, executable by at least one processor, include defining at least one question corresponding to at least one product of a plurality of products defined in a product catalog. The instructions further include generating one or more user-interfaces for ordering the at least one product from the product catalog, the one or more user-interfaces displaying the product and the at least one question.

### BRIEF DESCRIPTION OF THE DRAWINGS

The foregoing and other objects, features, and advantages of the present disclosure set forth herein will be apparent from the following description of particular embodiments of those inventive concepts, as illustrated in the accompanying drawings. It should be noted that the drawings are not necessarily to scale; however, the emphasis instead is being placed on illustrating the principles of the inventive concepts. Also, in the drawings the like reference characters refer to the same parts throughout the different views. The drawings depict only typical embodiments of the present disclosure and, therefore, are not to be considered limiting in scope.

FIG. 1 is a flowchart illustrating an example process for ordering communications products, according to aspects of the present disclosure.

FIG. 2 is a block diagram of a computer system for processing communications product orders, according to aspects of the present disclosure.

FIG. 3 is a block diagram illustrating an example product, according to aspects of the present disclosure.

FIGS. 4A-4H are example graphical user interfaces, according to aspects of the present disclosure, useful in performing various operations associated with the customer order capture functionality discussed herein.

FIG. 5 is an example block diagram of an order configuration platform, according to aspects of the present disclosure.

### DETAILED DESCRIPTION

Aspects of the present disclosure involve a dynamic and flexible order configuration engine platform that enables users, such as customers, communications service providers and corresponding sales and sales engineers, among others, the ability to configure and provision new and/or existing communications products and/or services dynamically, in near real-time. More particularly, one or more interactive interfaces may be generated that enable users the ability to configure, bundle, group, and/or otherwise associate products and/or services, offered by a communications service provider, into a single solution that may be offered for sale to customers. The interactive interfaces are dynamically driven by a product catalog operating in conjunction with a rules engine to increase both the accuracy of implementing the new and/or recently modified existing products, and the efficiency in which customer orders for such communications products are processed. The order configuration engine uses data from the product catalog to dynamically drive the interactive interfaces, automatically enabling customers to order the solutions, with minimal human intervention, effectively reducing the cost and time delays typically associated with providing such products to customers.

An illustrative process and system for providing interactive interfaces that enable the configuring and ordering of various products, such as communications products from a communications service provider, dynamically, in near real-time is depicted in FIGS. 1-2. In particular, FIG. 1 illustrates an example process 100 for generating one or more interactive interfaces, dynamically driven by an order configuration engine using data from the product catalog, all of which enable the processing of customer orders for new and/or recently modified communication products. FIG. 2 illustrates a computing environment 200 including an order configuration engine 202 operating in conjunction with various other hardware and/or software components that may be used to perform or otherwise execute the process 100.

As illustrated in FIG. 1, process 100 begins with generating one or more interactive interfaces/input forms (e.g. a user-interface or graphical user-interface) for configuring one or more products and/or services (operation 102). The interfaces may include various interactive elements, such as buttons, forms, fields, selections, inputs, streams, etc., for receiving input for quoting, ordering and configuring various products offered by a communications service provider.

The interfaces may be generated by the order configuration engine 212, which may be a personal computer, work station, server, mobile device, mobile phone, processor, and/or other type of processing device and may include one or more processors that process software or other machine-readable instructions. The order configuration engine 212 may further include a memory to store the software or other machine-readable instructions and data and a communication system to communicate via a wireline and/or wireless communications, such as through the Internet, an intranet, and Ethernet network, a wireline network, a wireless network, and/or another communication network. The order configuration engine 212 may include a database 220, which is a general repository of data including product data, product request data, user data, interface data, and/or any other data relating to generating interfaces for ordering and configuring products. The database 220 may include memory and one or more processors or processing systems to receive, process, query and transmit communications and store and retrieve such data. In another aspect, the database 220 may be a database server.

In one embodiment, as illustrated in FIG. 2, the product data and/or product information required to populate the interfaces generated by the order configuration engine 212 may be defined in a product catalog/product catalog management system 202 (“PCS”) that is configured to manage product data corresponding to one or more products and/or services referred to herein as products 203 offered by a communications service provider. The products 203 stored within the PCS 202 may generally relate to data, voice, security, video, etc. Example products 203 include: Internet services, private line services, content delivery network services, voice over internet protocol services, Internet broadcasting services, unified communications, converged data and voice services, cloud computing services, contact center services, Ethernet services, etc, to name a few. It is contemplated that any type of communications product capable of being offered by a communications service provider may be included in the products 203 and stored in the PCS 202. In various possible embodiments, the PCS 202 may be any commercially available product management system, such as the Tribold Agile Enterprise Product Management System, or Tribold EPM™, Amdocs® Enterprise Product Catalog, Pimcore Content and Product Management System. Alternatively, the PCS 202 may be proprietary.

Each of the products 203 may be associated with or correspond to one or more components 204. A component represents a configurable aspect of a product. Stated differently, a component represents or defines a fundamental independent characteristic or function of a product that, when combined with other components, articulates how a product will be implemented. For example, in one embodiment, a product may correspond to a “type” component that describes a particular type of product and/or service. For example, the products may be of type “capture”, “delivery”, “security”, among others. In another embodiment, a product may also correspond to or otherwise be associated with a “geographic location” component that describes the geographic locations in which a product will be located. In yet another example, a product may correspond to a “pricing scheme” component that describes the pricing mechanism that will be applied to the product when offered to customers. For example, the “pricing scheme” may include a multiplier that effectively increases the price, for example, due to accessing the product within a particular geographic location (e.g. based on the geographic location component). Alternatively, the “pricing scheme” may be a discount that reduces the price charged to customers for a particular product.

A product may correspond to an “association” component that associates the product with other products defined within the product catalog (PCS) 203. For example, a product may be associated with one, two or, three other products defined within the products 203, each of which having their own “type” component, “geographic location” component, and/or “pricing scheme” component. Thus, any product within the product 203 may be associated (e.g. grouped, bundled, combined, added) with any number of products, and a product may include or have multiple corresponding components of the same or different type. It is contemplated that components other than the components described above may be defined within the products catalog 203 and any and all of such components may be stored as apart of product data within the database 220.

In one embodiment, a product may correspond to a series of questions 205 that must be answered to enable proper configuration and/or provisioning of the product/service. Accordingly, a product may correspond to a “questionnaire” including a plurality of questions. For example, if the product were for a caching product and/or service, the question component may contain one or more questions relating to how the caching service should be provisioned, such as question requiring the definition of one or more properties, where a property identifies a chunk of data to be cached by the caching service. The questions may further include how a questioning requiring input that discerns how the various properties should be initially stored by the caching service, such as within a particular origin store. The questions may also include and/or require a question requiring input describing how long the content identified within the property should remain active. Thus, any question surrounding the specific details of how a particular product should be provisioned may be generated. Any such questions may optionally be arranged in a hierarchy. Stated differently, questions may be arranged so that an answer to one question may require an answer to another question and so on.

Referring again to FIG. 2, a user, such as a sales manager of a communications service provider, interested in defining a new product and/or defining configurable aspects of an existing product within the products 203 of the PCS 202, may access a client device 216 to initiate a product configuration request for defining a product and its corresponding configurable components and/or questions, which may be received by the order configuration engine 212 (operation 104). In response, the order configuration engine 212 may transmit instructions that may be processed and/or executed to generate, or otherwise display, one or more interactive interfaces or input forms (e.g. a user-interface) for configuring one or more components and/or attributes corresponding to the ordered product. The various user-interfaces may include interactive elements, such as buttons, forms, fields, selections, inputs, streams, etc., for receiving input to configure the components, attributes, etc., corresponding to the product.

The client device 216 may be a personal computer, work station, server, mobile device, mobile phone, tablet device, processor, and/or other processing device capable of implementing and/or executing server processes, software, applications, etc. Additionally, the client device 216 may include one or more processors that process software or other machine-readable instructions and may include a memory to store the software or other machine-readable instructions and data. The client device 216 may also include a communication system to communicate with the various components of the order configuration engine 212 via a wireline and/or wireless communications, such as through a network 218, such as the Internet, an intranet, an Ethernet network, a wireline network, a wireless network, a mobile communications network, and/or another communication network. The various interactive interfaces generated in response to the product order request may be displayed at the client device 216.

FIG. 3 is an example illustration of a product and its corresponding components stored within and/or managed by the PCS 202, according to one embodiment. As illustrated, assume the PCS 202 include a product “George” 302, which is a product offered by a telecommunications service provider. As illustrated, George 302 requires the configuration of a “type” component 304 indicating that George is a product and/or service relating to content delivery. Additionally, George requires the configuration of a “geographic location” component 306, indicating that George is a service that will only be available in the United States. Finally, George requires the configuration of an association component, which effectively associates George with at least one other product (e.g. a security type product), as illustrated at 308.

Referring now to FIG. 2, a rendering engine 224 of a quoting and order entry UI component 226 may include various functions, processes, and/or instructions that when executed, generate interfaces populated and/or driven by the products 203 defined within the PCS 202, effectively making such interfaces dynamic and data-driven (operation 106). In one particular embodiment, product data corresponding to the products 203 of the PCS 202 may be passed to the rendering engine 224 of a quoting and order entry UI component 226 according to a JavaScript Object Notation standard. Thus, the product data of the products 203 and any required description of how such product data should be displayed, presented, or otherwise interpreted, may be embedded in one or more dynamic data definitions and subsequently transmitted from the order configuration engine 212 to the rendering engine 224 of the quoting UI component 226. Although the product data has been described as being transmitted in accordance with JSON standards, such an implementation is not intended to be limiting in any way. Rather, it is contemplated that other types of data formats may be implemented, some of which include Extensible Markup Language (“XML”), ordered graph data language (“OGDL”), comma-separated values (“CSV”), among others.

The various interfaces generated by the rendering engine 224 of a quoting and order entry UI component 226 may be used to allow customers to submit product orders for such products, instantaneously and immediately after the product has been configured and/or otherwise reconfigured within the products 203 of the PCS 202. Accordingly, referring again to FIG. 1-2, a customer, interested in ordering one or more products defined within the products 203 of the PCS 202, may access the client device 216 to initiate a product order request for ordering one or more products, which may be received by the order configuration engine 212 (operation 108). In response, the rendering engine 226 of the quoting and order entry UI component 224 may transmit instructions to the client device 216 that may be processed and/or executed to generate, or otherwise display, one or more interactive interfaces or input forms (e.g. a user-interface) for configuring one or more components corresponding to the ordered product. The various user-interfaces may include interactive elements, such as buttons, forms, fields, selections, inputs, streams, etc., for receiving input to configure the components, attributes, etc., corresponding to the product.

FIGS. 4A-4G illustrate example interfaces generated by the rendering engine 226 of a quoting and order entry UI component 224 for ordering and provisioning various products, product solutions, product bundles (i.e. FIG. 4G), and the like. Referring initially to FIG. 4A, interface 400A includes an “agenda” section 402A articulating one or more questions in which a customer may provide input to order a product. Contained within the agenda 402A are one or more steps that a user, such as a customer, should work through to order a product, bundle of products, product solutions, etc. For example, in one embodiment, the interface 400A may include one or more interactive components, fields, forms, and/or the like for receiving data that corresponding to various steps required for configuring a product, as defined within the PCS 202. While interface 400A illustrates the various components on one single interface, it is contemplated that such components may be displayed and/or presented in separate and/or multiple interfaces.

In one particular embodiment, the agenda 402A may include a customer component 404A configured to receive and/or otherwise display information that uniquely describes a customer, such as name, identification number, address, contact information, and/or the like. FIG. 4B is an example screen shot of an interface 400B including various customer information components 404B that may be presented or otherwise displayed.

Referring again to FIG. 4A, the agenda 402A may include a product selection component 406A, which may be configured to receive input for configuring and provisioning a product, group of products, bundle of products, solution, or the like for various products contained with the product 203 of the PCS 202. FIG. 4C is an example screen shot of an interface 400C including various product selection components 406C that may be presented or displayed. The agenda 402A may further include a pricing component 408 configured to receive and/or otherwise display pricing information, such as for example a pricing scheme associated with a particular product. FIG. 4D is an example screen shot of an interface 400D including various pricing components 408D that may be presented or displayed. In the Illustrated embodiment, pricing for an origin store product is displayed.

Referring again to FIG. 4A, the agenda 402A may include a technical details component 410 configured to receive and/or otherwise display any questions corresponding to a particular product. For example, referring to the “Caching Service” example above, the technical details component may require input corresponding to the “properties question” and thereby requiring the user to define what chunk of data is to be cached. The agenda 402A may also include a quote component 412A configured to receive and/or otherwise display a pricing quote for a particular product. FIG. 4E is an example screen shot of an interface 400E including various quote components 412E that may be presented or displayed. Other features may be displayed on the various interfaces 400, such as for example shopping cart functionality, as is generally known in the art. Moreover, FIGS. 4F-4H are example screen shots of various interfaces corresponding to various other configurable aspects of products, and/or product bundles, product components, and the like.

Any of the various components of the agenda 402A may be submitted for verification (operation 110). More specifically, the order configuration engine 212 may interact with, and/or be in operable communication with the rules engine 208 that is configured to validate the configurations of products, and further, any information received via the various components of the agenda 402A. In particular, the rules engine 208 is configured to define and execute one or more rules 214 for verifying various aspects of the products 203 and any corresponding components or questions for products stored within the PCS 202. The rules 214 include policies, requirements, and/or conditional statements that are used to determine the validity and/or context of various product configurations or agenda 402A components made within and/or submitted to the order configuration engine 212. Thus, when a particular product and its associated components and/or questions are selected from the PCS 202, the order configuration engine 212 may query the rules engine 208 to identify rules applicable to the particular product. Subsequently, the order configuration engine 212 may use the identified rules to influence any interfaces the order configuration engine 212 may generate, such as, for example, limiting the display of any invalid product configurations (real time feedback to the user to facilitate easy collection of data) or limiting the display as a result of incomplete questions.

Once an order is submitted, output, such as a document (e.g. a pdf, report, web page, etc.) defining the order may be generated transmitted for processing and provisioning (operation 110). For example, the order may include various pricing schemes, quotes, terms and agreement information, and/or other data relating to the ordered product and/or service. Subsequently, the order configuration engine 212 may transmit the order to a provisioning system 228 that may process the order and subsequently prepare, equip, provision, initialize, the various hardware and/or software components required to provide the product and/or service to users. In the event that the product and/or service require manual configurations, the provisioning system 228 may communicate with various workflow systems capable of scheduling such procedures. The provisioning system 228 may be a personal computer, work station, server, mobile device, mobile phone, tablet device, processor, and/or other processing device capable of implementing and/or executing server processes, software, applications, etc. The order and/or other product data may also be sent to various other systems for processing, such as billing systems, management systems, sales systems, customer service systems, among others.

FIG. 5 is example schematic diagram of a computing system implementing an order configuration engine 212 that may be use to receive and process orders for various communications products, according to one embodiment. The computing system for the order configuration engine 212 includes a bus 501 (i.e., interconnect), at least one processor 502, at least one communication port 503, a main memory 504, a removable storage media 505, a read-only memory 506, and a mass storage device 507. Processor(s) 502 can be any known processor, such as, but not limited to, an Intel® Itanium® or Itanium 2® processor(s), AMD® Opteron® or Athlon MP® processor(s), or Motorola® lines of processors. Communication port 503 can be any of an RS-232 port for use with a modem based dial-up connection, a 10/100 Ethernet port, a Gigabit port using copper or fiber, or a USB port. Communication port(s) 503 may be chosen depending on a network such as a Local Area Network (LAN), a Wide Area Network (WAN), or any network to which the computer system 100 connects. The order entry platform 112 may be in communication with peripheral devices (e.g., display screen 530, input device 516 via Input/Output (I/O) port 509.

Main memory 504 can be Random Access Memory (RAM) or any other dynamic storage device(s) commonly known in the art. Read-only memory 506 can be any static storage device(s) such as Programmable Read-Only Memory (PROM) chips for storing static information such as instructions for processor 502. Mass storage device 507 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices, may be used.

Bus 501 communicatively couples processor(s) 502 with the other memory, storage and communications blocks. Bus 501 can be a PCI/PCI-X, SCSI, or Universal Serial Bus (USB) based system bus (or other) depending on the storage devices used. Removable storage media 505 can be any kind of external hard drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), etc.

Embodiments herein may be provided as a computer program product, which may include a machine-readable medium having stored thereon instructions which may be used to program a computer (or other electronic devices) to perform a process. The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

As shown, main memory 504 is encoded with the configuration application 550-1 that supports functionality as discussed above and as discussed further below. For example, in one embodiment, the configuration application 550-1 may include or otherwise implement the various processes and/or instructions described herein. Configuration application 550-1 (and/or other resources as described herein) can be embodied as software code such as data and/or logic instructions (e.g., code stored in the memory or on another computer readable medium such as a disk) that supports processing functionality according to different embodiments described herein. During operation of one embodiment, processor(s) 502 accesses main memory 504 via the use of bus 501 in order to launch, run, execute, interpret or otherwise perform the logic instructions of the configuration application 550-1. Execution of configuration application 550-1 produces processing functionality in configuration process 550-2. In other words, the configuration process 550-2 represents one or more portions of the configuration application 550-1 performing within or upon the processor(s) 202 in the computer system 500.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A communications product quoting and order entry system comprising:
at least one processor to define at least one question corresponding to at least one product of a plurality of products defined in a product catalog; and
a rendering engine to generate one or more user-interfaces for ordering the at least one product from the product catalog, the one or more user-interfaces displaying the product and the at least one question.

2. The system of claim 1, wherein the product catalog further includes at least one component defining a configurable aspect of the at least one product and wherein the one or more user-interfaces further displays the component.

3. The system of claim 1, further comprising:
embedding the at least one question into a dynamic data definition in accordance with Javascript Object Notation (“JSON”) format; and
transmitting the dynamic data definition encoded with the at least one question to the rendering engine for processing to generate the one-or-more user-interfaces.

4. The system of claim 1, wherein to display the at least one question comprises displaying one or more interactive elements for receiving input corresponding to the question and wherein the at least one processor is further configured to receive a input of the at least one question and verify the input by:
executing one or more rules of a rules engine, the one or more rules corresponding to the at least one question; and
receiving an indication that the input passed the one or more rules.

5. The system of claim 5, further comprising:
when the input passed the one or more rules, generating an order and providing the order to a provisioning system capable of provisioning the product.

6. The system of claim 1, wherein each product of the plurality of products is a telecommunication product provided by a telecommunications service provider.

7. A method for quoting and ordering products comprising:
defining, at at least one processor, at least one question corresponding to at least one product of a plurality of products defined in a product catalog; and
generating, at the at least one processor, one or more user-interfaces for ordering the at least one product from the product catalog, the one or more user-interfaces displaying the product and the at least one question.

8. The method of claim 7, wherein the product catalog further includes at least one component defining a configurable aspect of the at least one product and wherein the one or more user-interfaces further displays the component.

9. The method of claim 7, further comprising:
embedding the at least one question into a dynamic data definition in accordance with Javascript Object Notation (“JSON”) format; and
transmitting the dynamic data definition encoded with the at least one question to the rendering engine for processing to generate the one-or-more user-interfaces.

10. The method of claim 7, wherein to display the at least one question comprises displaying one or more interactive elements for receiving input corresponding to the question and wherein the at least one processor is further configured to receive a input of the at least one question and verify the input by:
executing one or more rules of a rules engine, the one or more rules corresponding to the at least one question; and
receiving an indication that the input passed the one or more rules.

11. The method of claim 10, further comprising:
when the input passed the one or more rules, generating an order and providing the order to a provisioning system capable of provisioning the product.

12. The method of claim 7, wherein each product of the plurality of products is a communications product provided by a communications service provider.

13. A non-transitory computer readable medium encoded with instructions for ordering products, the instructions, executable by a processor, comprising:
defining at least one question corresponding to at least one product of a plurality of products defined in a product catalog; and
generating one or more user-interfaces for ordering the at least one product from the product catalog, the one or more user-interfaces displaying the product and the at least one question.

14. The non-transitory computer readable medium of claim 13, wherein the product catalog further includes at least one component defining a configurable aspect of the at least one product and wherein the one or more user-interfaces further displays the component.

15. The non-transitory computer readable medium of claim 13, further comprising:
embedding the at least one question into a dynamic data definition in accordance with Javascript Object Notation (“JSON”) format; and
transmitting the dynamic data definition encoded with the at least one question to the rendering engine for processing to generate the one-or-more user-interfaces.

16. The non-transitory computer readable medium of claim 13, wherein to display the at least one question comprises displaying one or more interactive elements for receiving input corresponding to the question and wherein the at least one processor is further configured to receive a input of the at least one question and verify the input by:
executing one or more rules of a rules engine, the one or more rules corresponding to the at least one question; and
receiving an indication that the input passed the one or more rules.

17. The non-transitory computer readable medium of claim 16, further comprising:
when the input passed the one or more rules, generating an order and providing the order to a provisioning system capable of provisioning the product.

18. The non-transitory computer readable medium of claim 13, wherein each product of the plurality of products is a communications product provided by a communications service provider.
